(19) United States
(12) Patent Application Publication
(10) Pub. No.: US 2003/0043581 A1
(43) Pub. Date: Mar. 6, 2003

(54) Vehicle jack with directable light source

(76) Inventor: Robert R. Finnigan, Renton, WA (US)

Correspondence Address: Robert R. Finnigan, P. O. Box 58399, Renton, WA, 98058, US

(21) Appl. No.: 09/941,140

(22) Filed: Aug. 28, 2001

(51) Int. Cl. F21V 33/00; F21V 21/30

(52) U.S. Cl. 362/253; 362/459; 362/427; 254/45

(57) ABSTRACT

Disclosed is a combination vehicle jack and directable light source. The light source provides one or more beams of light which are independently directable relative to the base of the jack. The light source may be battery powered, pivotal, flexible, and/or detachable.

### TECHNICAL FIELD

This invention relates to an improved combination of a vehicle jack and a directable light source such that one or more beams of light can be focused on the anticipated contact point between the jack and vehicle chassis, on a work zone under, on, or around the vehicle, or as a warning to approaching traffic.

### BACKGROUND

Portable jacks or lifting mechanisms are commonly used in professional automobile service shops, home garages, and in both the garages and pits of stock car racing teams. Unlike the lightweight, limited use jacks that are supplied by the factory with new automobiles, garage jacks, also known as service jacks or dolly jacks, have a relatively low and long wheel-supported base. Similar in design are trolley jacks which are smaller and have a small wheel base. An operating handle is pivotally attached at one end of the base and a lifting arm is usually pivotally mounted near the center of the base. A saddle or cup, designed to contact the vehicle chassis, is associated with the opposite end of the lifting arm. Although some users carry small versions of such jacks in their vehicle trunk for emergency use, these devices are more commonly used in a garage setting.

Many amateur mechanics, and even racing teams involved in night racing, are forced to work in dark or dimly lit situations. This is especially the case for those who are forced to engage in emergency roadside repairs. Even in ideal garage conditions, the lighting is usually very dim under a vehicle. Although separate electrical lighting devices (known as work lights or trouble lights) or battery-powered flash lights may be used to help the mechanic properly position the jack under a vehicle, there are some situations where separate lighting devices are not available or are not used by the mechanic due to the extra time and inconvenience required.

U.S. Pat. No. 219,903, issued to Edward M. Pfauser on Oct. 29, 1940, addressed a similar problem. The invention shown in the Pfauser patent is a combination of a conventional hydraulic garage service jack with a battery-powered light fixture mounted on top of the jack base. A significant shortcoming of this device, however, is that it provides only general, defuse illumination and is incapable of providing a focused beam of light directable independent of the base's position. U.S. Pat. Nos. 4,872,230 and 5,085,407 disclose motorized vehicle jacks powered by the vehicle's electrical system and show also fixed-position lights having the same inherent shortcomings.

### SUMMARY OF THE INVENTION

The present invention provides a jack with a light source that is selectively directable independent of the position of the jack.

In preferred form, the jack may include a transportable lifting mechanism at the base and a lifting member. The light source then, which is positioned thereon, provides one or more beams of light which are independently directable relative to the base.

One or more lights may be detachable, such as with a phono plug connection and may include secondary pivot and will allow a full range of motion for directing the light beam. Alternatively, the light source may include a flexible, positionable extension member.

Also in preferred form, the light source is powered by an on-board battery pack, which may be located on the base of the jack. A second light source may be provided which flashes a colored beam in order to provide a safety warning.

### BRIEF DESCRIPTION OF THE DRAWING

Like reference numerals are used to indicate like parts throughout the various figures of the drawing, wherein:

FIG. 1 is an exploded, pictorial view of a preferred embodiment of the invention;

FIG. 2 is a partial cross-section of a preferred embodiment of the invention showing the position of a battery pack;

FIG. 3 is a side-view of a preferred light element for use with a preferred embodiment of the present invention;

FIG. 4 is a top view thereof;

FIG. 5 is a sectional view thereof taken substantially along line 5-5 of FIG. 3; and

FIG. 6 is an alternate, flexible body light fixture that may be used with a preferred embodiment of the present invention.

### BEST MODE FOR CARRYING OUT THE INVENTION

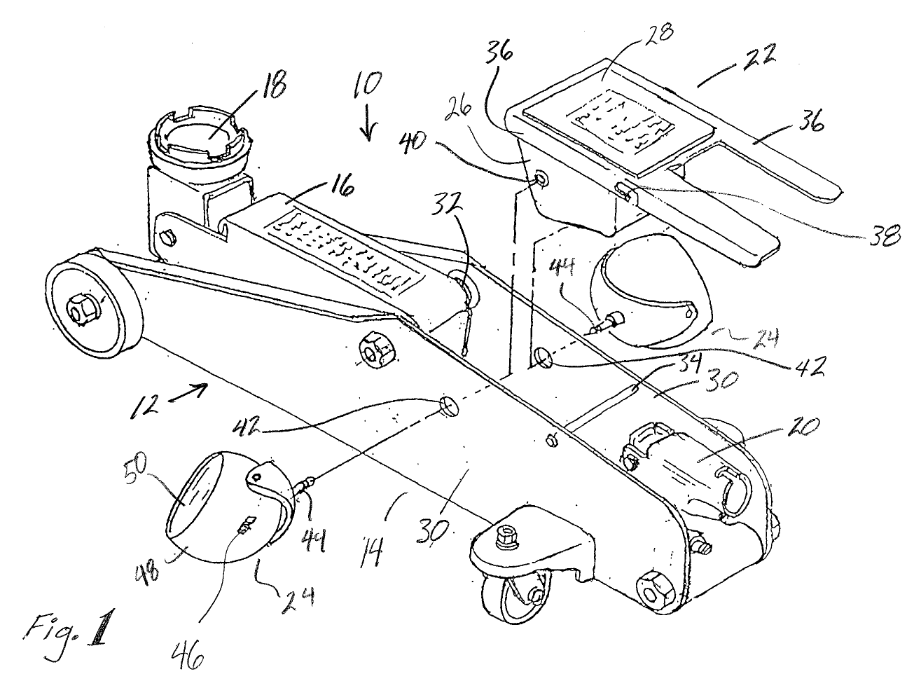

Referring now to the various figures of the drawing and first FIG. 1, therein as shown at 10, a partially exploded view of a preferred embodiment of the present invention. One part of the invention includes a typical floor jack 12 also known as a garage jack, service jack, trolley jack, or dolly jack, having a relatively low and long wheel-supported base 14 and a centrally-pivoted lifting member 16 or arm. At the outward end of the lifting member 16 there is a saddle or cup 18 which is designed to contact and engage the vehicle chassis or underside of whatever object is being lifted. At an opposite end of the base, 14 there is a pivoting lever 20 which may receive a detachable handle (not shown) such as by bayonet connection. Up and down pivotal movement of this member 20 operates a hydraulic piston which, in turn, pivots the lifting arm 16 causing it to extend upwardly. The structure described thus far, and many variants thereof, is well known in the art. Alternatively, the invention could include the jack in another commonly-known form. For example, the jack could be the screw jack, the telescopic hydraulic piston jack, or even a scissor jack.

According to a preferred embodiment of the present invention, an on-board battery pack 22 and one or more pivotal, removable lighting fixtures 24 are provided in combination with the jack 12.

Referring now also to FIG. 2, it can be seen that the battery pack 22 is sized and shaped to hold a plurality of dry cell batteries, typically in series, in a well known manner. This unit includes a housing 26 and an access door or panel, 28. In preferred form, the housing 26 is sized and shaped to fit between a pair of lateral rails or beams 30 which make up the base 14 of the jack 12. At some point between the actuation lever 20 and lift member pivot 32 there is typically a cross-tie pen or bolt 34 which provides increased strength and rigidity to the jack 12. The battery pack 22 may include lateral mounting flanges 36 which extend over upper edges of the base rails 30 and which engage the cross-tie 34 with cooperatively-positioned slots or openings 38.

Also in preferred form, the battery pack 22 includes one or more electrically-conductive phono jacks 40. These may be typical ¼″, 2-conductor, panel-mounted hardware.

Openings 42 are provided in the base rails 30 at locations coordinated with the installed position of the phono jacks 40. Each of the detachable light fixtures 24 includes a cooperative phono plug which may be inserted through the opening 42 for engagement into a phono jack 40. This provides a connection which is disengagable, rotatable, and electrically-conductive. Additionally, both the plug and jack 40,42 hardware items are inexpensive, off-the-shelf components.

As has been essentially described thus far, it can be seen that the present invention provides combined vehicle jack and directable light source capable of providing one or more beams of light focused on the anticipated contact point between the jack and vehicle chassis, on a work zone under, on or around the vehicle, or as a warning to approaching traffic. Construction details for this preferred embodiment are provided below.

The electrical circuitry of the battery pack 22 is simple and many variations would be readily apparent to a person of ordinary skill in the art. Preferably, the power source would be from between two to six C or D size dry cell batteries. According to the choice of a designer, the cells may be wired in series to provide maximum voltage or in parallel to provide maximum amperage. The phono jack 40 could be wired in parallel to the power source if DPST jacks are used or may be wired in series if the DPDT jacks are used. Typically, the phono jacks 40 should be mounted in a separated compartment in the power pack 22 from the batteries. This prevents potential damage to the jacks 40 or their connections while inserting or removing batteries, or in the event that a dry cell leaks or corrodes.

An on-off switch, 46 may be provided on each light fixture 24 to allow separate control, or may be integrated into the cover 28 of the battery pack 22.

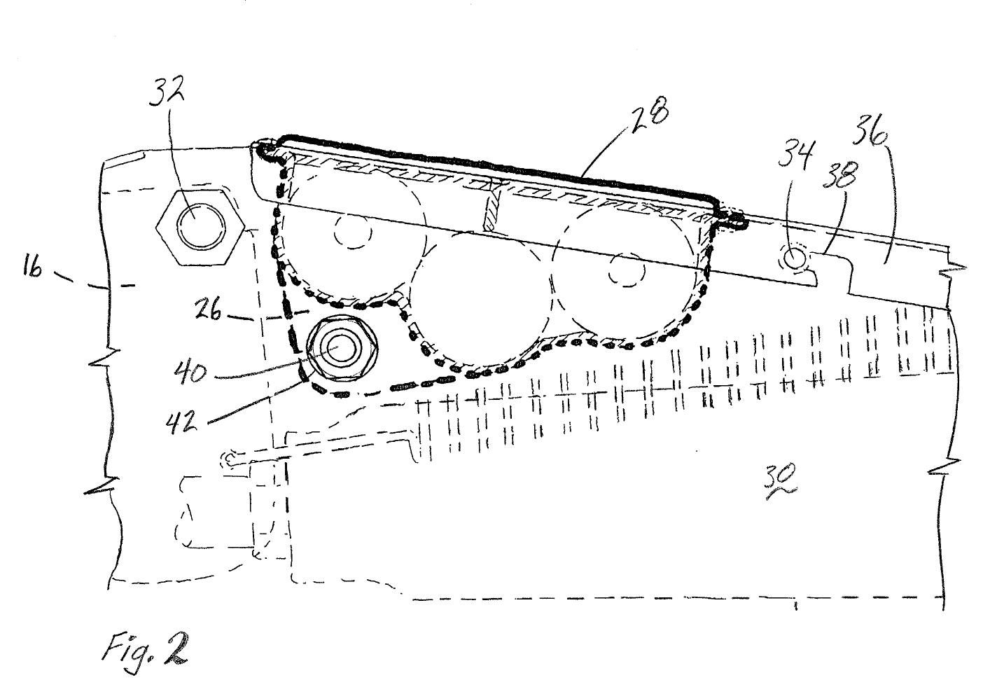

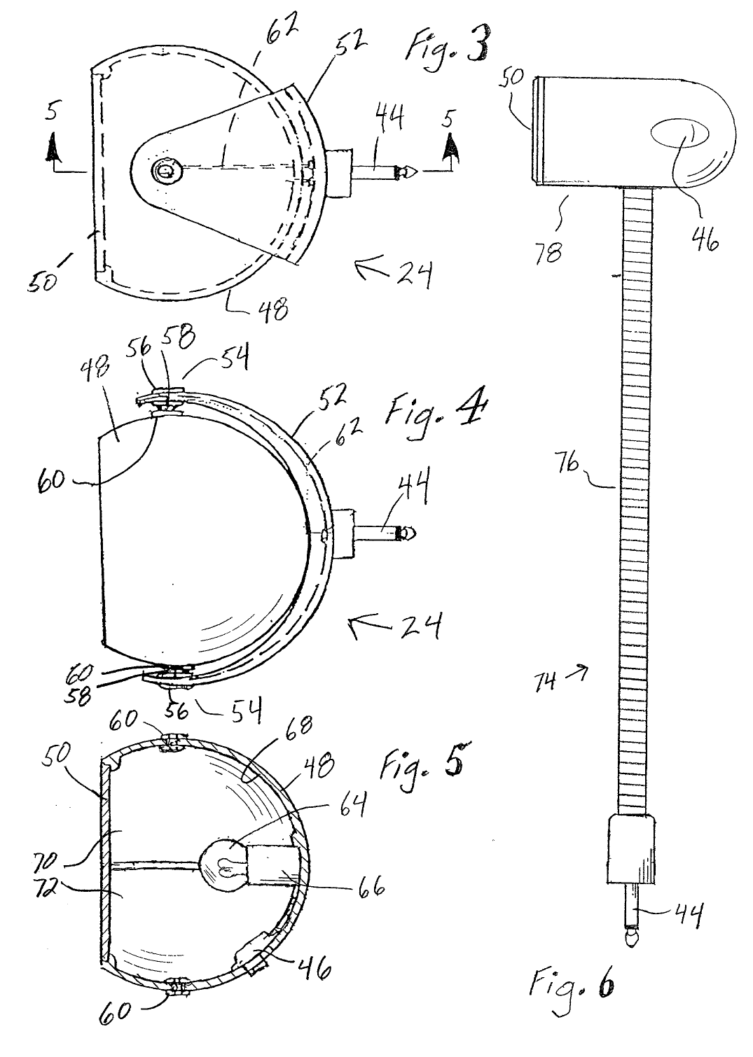

A wide variety of directable light fixtures may be used with the present invention. A preferred form is shown in FIGS. 1 and 3-5. In the preferred form, the light fixture 24 comprises a housing 28 having a substantially spherical or rounded shape, less a portion that comprises the protective or focusing lens 50. The housing 48 is mounted on larger-radius portions of a sphere provides a somewhat U-shaped support 52. The support 52 and housing 48 connected with an electrically-conducting, pivoting interface 54.

In preferred form, this interface 54 could comprise a metallic rivet, a screw-like fastener, or may be a two-part construction in which a first part 56 is mounted on the support 52 and includes a detent protrusion 58 which engages an opening or impression in a second part 60 which is mounted to the housing 48. Such a connection allows electrical power to be conducted through the metallic parts 56, 58, 60 and for the housing 48 to rotate relative to the support 52. These connections 54 may include a common rivet or threaded connector, as is well known. Likewise, the connections 54 may be accomplished through a friction fit in which the housing 48 is squeezed between opposing arms of the U-shaped support 52.

Electrical power can be conducted to the light fixture 24 through the phono plug 44 which provides connection of two separate conductors. These conductors can then continue in the form of a wire (not shown) that is either embedded or fitted into an inside groove 62 in opposite arms of the U-shaped support 52. Separate conductors may extend in opposite directions and are conductively attached to the first portion 56 of the pivotal connection 54. Conductive contact is then made through the detent 58 or other connector to the second portion 60 of the connection 54. In this manner, separate poles of electrical energy are conducted to the housing 48 of the light fixture 24.

Referring now also to FIG. 5, therein can be seen the internal structure of the housing 48 which includes the light bulb 64 and socket 66. In place of the light bulb 64 and socket 66, could be an array of light emitting diodes or any other suitable light source. In preferred form, the interior side 68 of the housing 48 is covered, layered, or coated in two separate portions 70, 72 with a light-reflecting and electrically-conductive material, such as a metallic foil or film layer. These separate portions 70, 72 are separately connected to one of the metal connection portions 60 and two separate conductors of the socket 66. In this manner, electrical power is transferred from the connection 54 through the separate portions 70, 72 of the inside coating 68 to the socket 66 and light bulb 64. Alternatively, a wire (not shown) could extend between the connector 60 and socket 66, either embedded in the housing 48, inserted in an internal groove (not shown) or simply extending behind a traditional conical or parabolic reflector (not shown). Alternatively, a flexible wire of well-known variety may simply connect the phono plug 44 to the socket 66, provided that sufficient slack is provided to allow the housing 48 to pivot sufficiently in either direction within the U-shaped support 52. A conventional push-button, rocker, or slide switch 46 may be mounted at any suitable location on housing 48 and electrically connected to the socket 66.

Referring now to FIG. 6, therein is shown at 74 an alternate embodiment of a light fixture. This alternate fixture 74 includes the above-described phono plug connector 44 at one end of an elongated “gooseneck” 76. At the opposite end of the gooseneck 76 is a positionable light fixture housing 78, the particular structure of which is not relevant to the present invention. Gooseneck 76 may be of a standard, well-known construction which is bendable and which holds its shape once positioned.

Of course, two or more identical lighting fixtures could be used or a combination of different types of positionable light devices could be selected. An electronic flasher could be employed in combination with a red or amber lense cap (not shown) in order to provide a visible warning device. Additionally, an adjustable reflector or lens which allows the user to select between a wide beam or narrow, focus beam be added to either of the light structures described above or other lighting fixture.

The specific structural details of the invention are not critical. The above-described and illustrated embodiment is only an example of the invention. Many changes and adaptations may be made to the above-described embodiments without departing from the spirit and scope of the invention. Patent protection is not to be determined by or limited to the disclosed, preferred embodiment, but rather by the claim or claims which follow, construed by use of established rules of patent claim construction, including the doctrine of equivalence and reversal of parts.

What I claim is:

1. A jack, such as for lifting a vehicle, in combination with a directable light source, comprising:
a transportable lift mechanism having a base and a lifting member; and
a light source providing one or more beams of light directable independent of the base.

2. The combination of claim 1, wherein the light source is battery powered.

3. The combination of claim 2, wherein the batteries are mounted on the base.

4. The combination of claim 1, wherein the light source is detachable from the lifting mechanism.

5. The combination of claim 4, further comprising 9 phono plug connection between the light source and the power source located on the lifting mechanism.

6. The combination of claim 5, wherein the phono plug connection provides a pivotal connection.

7. The combination of claim 6, wherein the light source includes 9 second pivotal joint to provide a second direction of movement.

8. The combination of claim 1, wherein the light source includes a pivotal mechanism for directing the one or more beams of light.

9. The combination of claim 1, wherein the light source includes a flexible, positionable extension member.

10. The combination of claim 9, wherein the light source is detachable from the transportable lifting mechanism.

11. The combination of claim 1, wherein a second beam of light is independently directable of a first beam of light.

12. The combination of claim 11, wherein the second light flashes.

13. The combination of claim 12, wherein the second light source provides a colored beam of light.

14. A jack, such as for lifting a vehicle, in combination with a directable light source, comprising:
a jack means having a base; and
a light producing means having one or more means for lit directing a light beam independent of the base.
